(19) United States
(12) Patent Application Publication
(10) Pub. No.: US 2020/0204062 A1
(43) Pub. Date: Jun. 25, 2020

(54) SNUBBER CIRCUIT, CONTROL CIRCUIT, AND INFORMATION PROCESSING APPARATUS

(71) Applicant: Nidec Corporation, Kyoto (JP)

(72) Inventor: Hidetoshi IKEDA, Kyoto (JP)

(21) Appl. No.: 16/706,887

(22) Filed: Dec. 9, 2019

(30) Foreign Application Priority Data
Dec. 25, 2018 (JP) 2018-241543

(51) Int. Cl. H02M 1/34; H02M 1/44

(52) U.S. Cl. CPC H02M 1/34; H02M 2001/344; H02M 1/44

(57) ABSTRACT

A snubber circuit is connected to a target switching element, and includes a first capacitor and a first resistor which has a variable resistance value.

### CROSS REFERENCE TO RELATED APPLICATION

The present application claims priority under 35 U.S.C. § 119 to Japanese Application No. 2018-241543 filed on Dec. 25, 2018, the entire contents of which are hereby incorporated herein by reference.

### 1. FIELD OF THE INVENTION

The present disclosure relates to a snubber circuit, a control circuit, and an information processing apparatus.

### 2. BACKGROUND

Studies and developments have been made about a technology for reducing noise of a circuit provided with a switching element, such as, for example, a converter circuit or an inverter circuit.

In connection therewith, a module is known which includes a switching element for switching the state of electrical continuity of a target transmission line, and a snubber circuit for reducing noise caused by a surge voltage that is generated at the time of a switching of the switching element.

Here, it is not possible to actively vary the resistance value of a resistor included in the known snubber circuit. Accordingly, the snubber circuit may not be able to sufficiently reduce the noise caused by the surge voltage that is generated at the time of a switching of the switching element, with which the snubber circuit is provided. In this case, an adjustment of, for example, replacing the resistor with another resistor having a different resistance value is performed on the snubber circuit. As a result, the snubber circuit may involve an increase in a time required for an adjustment performed at the time of a radiation noise measurement.

### SUMMARY

A snubber circuit according to an example embodiment of the present disclosure is connected to a target switching element, and includes a first capacitor, and a first resistor with a variable resistance value.

A control circuit according to an example embodiment of the present disclosure controls the resistance value of the first resistor included in the snubber circuit.

An information processing apparatus according to an example embodiment of the present disclosure reduces radiation noise of an electronic device including the snubber circuit. The electronic device is placed in an anechoic chamber, and the information processing apparatus acquires an intensity of an electromagnetic wave emitted from the electronic device and received by an antenna in the anechoic chamber as radiation noise information representing the magnitude of the radiation noise, and change the resistance value of the first resistor based on the acquired radiation noise information.

An information processing apparatus according to another example embodiment of the present disclosure reduces radiation noise of an electronic device including the snubber circuit. The snubber circuit acquires a voltage between terminals of the target switching element, and change the resistance value of the first resistor based on the acquired voltage between the terminals.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a diagram explaining an outline of a snubber circuit 1 according to an example embodiment of the present disclosure.

FIG. 2 is a truth table showing an example of correspondences between a 4-bit control signal, a row address signal, a first switching element control signal, a column address signal, and a second switching element control signal according to an example embodiment of the present disclosure.

FIG. 3 is a diagram illustrating a specific example structure of the snubber circuit 1.

FIG. 4 is a diagram illustrating an example package structure of a power module 3 including a field-effect transistor 2 and the snubber circuit 1.

FIG. 5 is a diagram illustrating an example application of the power module 3 illustrated in FIG. 4 to a step-up circuit 101.

FIG. 6 is a diagram illustrating an example application of the power module 3 illustrated in FIG. 4 to an inverter circuit 102.

FIG. 7 is a diagram illustrating an example structure of a measuring system used in measuring radiation noise of an electronic device 20 including the power module 3 illustrated in FIG. 4.

FIG. 8 is a flowchart illustrating an example flow of a procedure performed by an information processing apparatus 40 to perform a measurement of the radiation noise of the electronic device 20 according to an example embodiment of the present disclosure.

FIG. 9 is a diagram illustrating a specific example structure of the field-effect transistor 2 with a snubber circuit 1A according to a modification of the above example embodiment of the present disclosure connected thereto.

FIG. 10 is a diagram illustrating an example structure of a step-up circuit 101A including a power module 3A according to an example embodiment of the present disclosure.

FIG. 11 is a diagram illustrating an example structure of an inverter circuit 102A including the power module 3A.

FIG. 12 is a flowchart illustrating an example flow of a procedure performed by a microcomputer to adjust at least one of the resistance value of a first resistor R and the capacitance of a first capacitor C in the power module 3A according to an example embodiment of the present disclosure.

### DETAILED DESCRIPTION

Hereinafter, example embodiments of the present disclosure will be described with reference to the accompanying drawings. In the description of the example embodiments, conductors that transfer electrical signals will be referred to as transmission lines. Each transmission line may be, for example, a conductor printed on a board, a conducting wire, such as a conductor in the shape of a line, or the like.

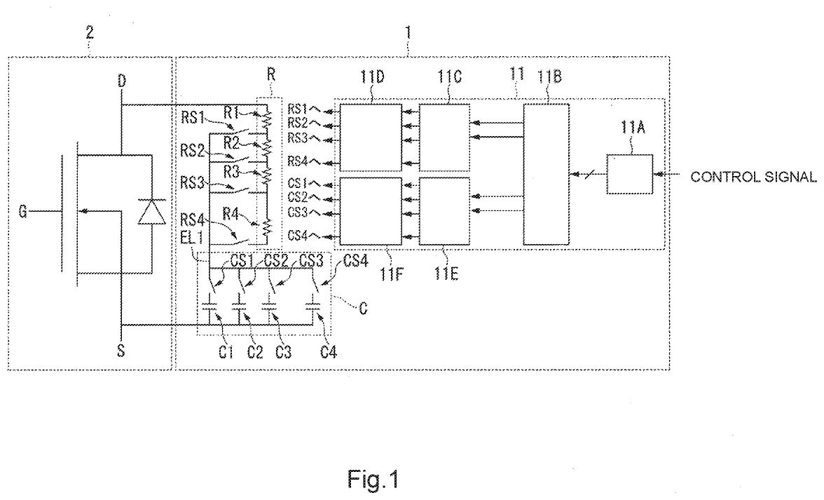

FIG. 1 is a diagram for explaining an outline of a snubber circuit 1 according to an example embodiment of the present disclosure.

The snubber circuit 1 is connected to a target switching element. The target switching element refers to a switching element to which the snubber circuit 1 is connected. The snubber circuit 1 is arranged to reduce noise caused by a surge voltage that is generated at the time of a switching of the target switching element.

The target switching element is, for example, a field-effect transistor. Note that the target switching element may alternatively be another switching element instead of the field-effect transistor. In the description of the present example embodiment, an example case where the target switching element is a field-effect transistor 2 as illustrated in FIG. 1 is described. That is, in the description of the present example embodiment, the snubber circuit 1 connected to the field-effect transistor 2 is described.

The field-effect transistor 2 is, for example, an n-type metal-oxide-semiconductor field-effect transistor (MOSFET). Note that the field-effect transistor 2 may alternatively be a p-type MOSFET instead of the n-type MOSFET. The target switching element may alternatively be another transistor, such as, for example, an IGBT, instead of the field-effect transistor 2. The target switching element may alternatively be another switching element other than transistors.

The snubber circuit 1 includes a first capacitor C, and a first resistor R capable of being varied in a resistance value. Thus, the snubber circuit 1 is capable of adjusting the resistance value of the first resistor R when measurement of radiation noise is performed, without the need to replace the first resistor R with another resistor. The other resistor means a resistor having a resistance value different from that of the first resistor R. As a result, the snubber circuit 1 is able to reduce a time required to adjust the resistance value of the first resistor R when the measurement of the radiation noise is performed, when compared to the case where the resistance value of a resistor included in a conventional snubber circuit is adjusted.

The first resistor R includes two or more second resistors connected in series. In the description of the present example embodiment, an example case where the first resistor R includes only the two or more second resistors connected in series as illustrated in FIG. 1 is described. In addition, in the description of the present example embodiment, an example case where the two or more second resistors are four second resistors R1, R2, R3, and R4 as illustrated in FIG. 1 is described.

The four second resistors may have either the same resistance value or different resistance values. An example case where each of the four second resistors has the same resistance value will be described below.

In addition, the snubber circuit 1 further includes two or more first switching elements. In the description of the present example embodiment, an example case where the two or more first switching elements are four first switching elements RS1, RS2, RS3, and RS4 as illustrated in FIG. 1 is described. In the description of the present example embodiment, for the sake of convenience in description, each of the first switching elements RS1 to RS4 is referred to as a first switching element RS unless they need to be differentiated from each other. In the present example embodiment, the number of first switching elements is equal to the number of second resistors. Note that the number of first switching elements should be two or more, but may be smaller or greater than the number of second resistors.

The four first switching elements RS are arranged to change the number of second resistors that are electrically connected among the four second resistors. The second resistor(s) that are electrically connected mean one or more of the second resistors through which an electric current passes when a voltage is applied across the first resistor R. More specifically, in the snubber circuit 1, the number of second resistors that are electrically connected changes when the state of any of the four first switching elements RS is switched to an ON state or an OFF state.

Here, in the present example embodiment, as described above, the first resistor R includes only the two or more second resistors connected in series. In this case, the resistance value of the first resistor R is a combination of the respective resistance value(s) of the second resistor(s) that are electrically connected. In the case where the second resistors that are electrically connected are the second resistors R1 and R2, i.e., two second resistors, in the present example embodiment, for example, the resistance value of the first resistor R is a combination of the resistance value of the second resistor R1 and the resistance value of the second resistor R2. That is, in the snubber circuit 1, the resistance value of the first resistor R can be changed to a resistance value desired by a user by switching the state of any of the two or more first switching elements to the ON state or the OFF state.

Note that, in the present example embodiment, the ON state of a given switching element means that both ends of this switching element are electrically connected. Meanwhile, in the present example embodiment, the OFF state of the switching element means that both ends of the switching element are not electrically connected. Note that, when the switching element is a field-effect transistor, both ends of the switching element correspond to a drain terminal and a source terminal of the field-effect transistor.

More specifically, in the snubber circuit 1, one of the two second resistors that are positioned at both ends of the four second resistors connected in series is connected to a drain terminal D of the field-effect transistor 2. In the snubber circuit 1, of two terminals of each of the four second resistors, the terminal that is arranged on the opposite side with respect to the drain terminal D of the field-effect transistor 2 in the first resistor R is connected to the first capacitor C with the corresponding first switching element RS therebetween. Thus, in the snubber circuit 1, the number of second resistors that are electrically connected among the four second resistors changes when the state of one of the four first switching elements RS is switched to the ON state with the other three first switching elements RS being in the OFF state. As a result, in the snubber circuit 1, it is possible to make each combination of the states of the first switching elements RS uniquely correspond to a resistance value of the first resistor R. That is, the snubber circuit 1 allows the user to change the resistance value of the first resistor R to a desired resistance value with increased ease. Note that the drain terminal D of the field-effect transistor 2 is an example of one of two terminals of the target switching element.

Of two terminals of each of the four first switching elements RS, the terminal that is not connected to the second resistors is connected to the first capacitor C through one transmission line EL1.

The first capacitor C may be configured to be either capable or incapable of being varied in capacitance. In the description of the present example embodiment, an example case where the first capacitor C is capable of being varied in capacitance is described.

The first capacitor C includes two or more second capacitors connected in parallel. In the description of the present example embodiment, an example case where the two or more second capacitors are four second capacitors C1, C2, C3, and C4 as illustrated in FIG. 1 is described.

The four second capacitors may be arranged to have either different values of capacitance or the same value of capacitance. In the description of the present example embodiment, an example case where the four second capacitors have different values of capacitance is described.

In addition, the first capacitor C further includes two or more second switching elements arranged to change the state of electrical connection of one of two terminals of each of the four second capacitors. In the description of the present example embodiment, an example case where the two or more second switching elements are four second switching elements CS1, CS2, CS3, and CS4 as illustrated in FIG. 1 is described. In the description of the present example embodiment, for the sake of convenience in description, each of the second switching elements CS1 to CS4 is referred to as a second switching element CS unless they need to be differentiated from each other. In the present example embodiment, the number of second switching elements is equal to the number of second capacitors. Note that the number of second switching elements should be two or more, but may be smaller than the number of second capacitors.

In the example illustrated in FIG. 1, one of two terminals of each of the four second capacitors is connected to the aforementioned transmission line EL1. The other one of the two terminals is connected to a source terminal S of the field-effect transistor 2. In addition, on a transmission line that connects the transmission line EL1 and each of the second capacitors, one of the four second switching elements CS is arranged. Thus, the snubber circuit 1 allows the capacitance of the first capacitor C to be varied by switching the state of any of the four second switching elements to the ON state or the OFF state. As a result, the snubber circuit 1 is able to more securely reduce the noise caused by a surge voltage that is generated at the time of a switching of the field-effect transistor 2 when compared to the case where only the resistance value of the first resistor R is variable. Note that the snubber circuit 1 may alternatively be configured such that, on a transmission line that connects the source terminal S and each of the second capacitors, one of the four second switching elements CS is arranged.

In addition, in the present example embodiment, the snubber circuit 1 further includes a control circuit 11. Note that the snubber circuit 1 may alternatively be configured not to include the control circuit 11.

The control circuit 11 is arranged to control the resistance value of the first resistor R based on a control signal inputted from another device. More specifically, based on the control signal, the control circuit 11 switches the state of each first switching element RS as necessary to set the resistance value of the first resistor R to a resistance value corresponding to the control signal. In other words, based on the control signal, the control circuit 11 switches the state of each first switching element RS as necessary to change the resistance value of the first resistor R to the resistance value corresponding to the control signal.

In addition, the control circuit 11 is arranged to control the capacitance of the first capacitor C based on the control signal inputted from the other device. More specifically, based on the control signal, the control circuit 11 switches the state of each second switching element CS as necessary to set the capacitance of the first capacitor C to a capacitance value corresponding to the control signal. In other words, based on the control signal, the control circuit 11 switches the state of each second switching element CS as necessary to change the capacitance of the first capacitor C to the capacitance value corresponding to the control signal.

An example case where the control signal inputted from the other device to the control circuit 11 is a 4-bit serial signal will be described below. In addition, for the sake of convenience in description, the control signal inputted from the other device to the control circuit 11 will be hereinafter referred to simply as the control signal. Note that the control signal may alternatively be a serial signal having three or less bits, or a serial signal having five or more bits. Also note that the control signal may alternatively be a parallel signal instead of a serial signal.

The control circuit 11 includes, for example, a shift register 11A, an address buffer 11B, a row decoder 11C, a row drive circuit 11D, a column decoder 11E, and a column drive circuit 11F. Note that the control circuit 11 may alternatively have another structure capable of controlling the resistance value of the first resistor R, such as a structure including a central processing unit (CPU) and so on.

The aforementioned control signal is inputted from the other device to the shift register 11A. Once the control signal, which is a serial signal, is inputted to the shift register 11A, the shift register 11A converts the control signal to a 4-bit parallel signal through serial-to-parallel conversion. The shift register 11A outputs the parallel signal to the address buffer 11B as a 4-bit address signal in the snubber circuit 1.

Once the 4-bit address signal is inputted from the shift register 11A to the address buffer 11B, the address buffer 11B outputs, as a row address signal, an upper address in the inputted address signal to the row decoder 11C. In addition, in this case, the address buffer 11B outputs, as a column address signal, a lower address in the inputted address signal to the column decoder 11E.

Once the row address signal is inputted from the address buffer 11B to the row decoder 11C, the row decoder 11C decodes the inputted row address signal into a first switching element control signal based on row address correspondence information. The row decoder 11C outputs the decoded first switching element control signal to the row drive circuit 11D. The row address correspondence information is information in which, with respect to each of a plurality of row address signals, the row address signal is associated with a first switching element control signal corresponding to the row address signal. The first switching element control signal is a signal for switching the state of each first switching element RS to the ON state or the OFF state as necessary.

Once the first switching element control signal is inputted from the row decoder 11C to the row drive circuit 11D, the row drive circuit 11D switches the state of each first switching element RS to the ON state or the OFF state as necessary in accordance with the inputted first switching element control signal.

Once the column address signal is inputted from the address buffer 11B to the column decoder 11E, the column decoder 11E decodes the inputted column address signal into a second switching element control signal based on column address correspondence information. The column decoder 11E outputs the decoded second switching element control signal to the column drive circuit 11F. The column address correspondence information is information in which, with respect to each of a plurality of column address signals, the column address signal is associated with a second switching element control signal corresponding to the column address signal. The second switching element control signal is a signal for switching the state of each second switching element CS to the ON state or the OFF state as necessary.

Once the second switching element control signal is inputted from the column decoder 11E to the column drive circuit 11F, the column drive circuit 11F switches the state of each second switching element CS to the ON state or the OFF state as necessary in accordance with the inputted second switching element control signal.

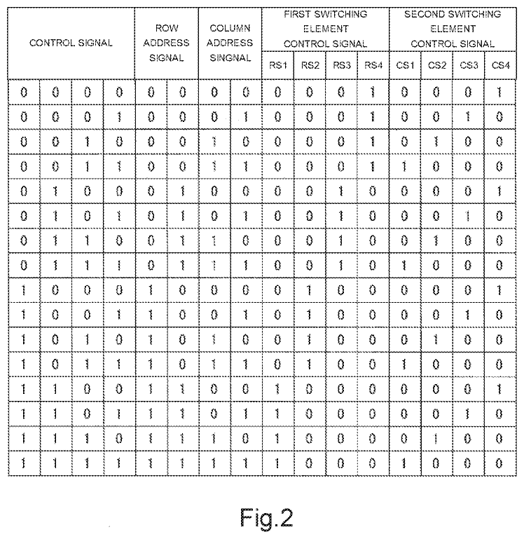

Here, FIG. 2 is a truth table showing an example of correspondences between the 4-bit control signal, the row address signal, the first switching element control signal, the column address signal, and the second switching element control signal. In FIG. 2, “RS1” represents the first switching element RS1. In FIG. 2, “RS2” represents the first switching element RS2. In FIG. 2, “RS3” represents the first switching element RS3. In FIG. 2, “RS4” represents the first switching element RS4. In FIG. 2, “CS1” represents the second switching element CS1. In FIG. 2, “CS2” represents the second switching element CS2. In FIG. 2, “CS3” represents the second switching element CS3. In FIG. 2, “CS4” represents the second switching element CS4.

The truth table showing the correspondences between the row address signal and the first switching element control signal illustrated in FIG. 2 is an example of the aforementioned row address correspondence information. In addition, the truth table showing the correspondences between the column address signal and the second switching element control signal illustrated in FIG. 2 is an example of the aforementioned column address correspondence information.

In the case of the example illustrated in FIG. 2, if “0011” is inputted as the control signal, for example, the address buffer 11B outputs, as the row address signal, the upper address “00” to the row decoder 11C. In addition, in this case, the address buffer 11B outputs, as the column address signal, the lower address “11” to the column decoder 11E.

In addition, in the case of the example illustrated in FIG. 2, if “00” is inputted as the row address signal, for example, the row decoder 11C outputs, as the first switching element control signal, “0001” to the row drive circuit 11D. If “11” is inputted as the column address signal, the column decoder 11E outputs, as the second switching element control signal, “1000” to the column drive circuit 11F.

In addition, in the case of the example illustrated in FIG. 2, if “0001” is inputted as the first switching element control signal, for example, the row drive circuit 11D switches the state of the first switching element RS1 to the OFF state. In this case, the row drive circuit 11D switches the state of the first switching element RS2 to the OFF state. In this case, the row drive circuit 11D switches the state of the first switching element RS3 to the OFF state. In this case, the row drive circuit 11D switches the state of the first switching element RS4 to the ON state.

In addition, in the case of the example illustrated in FIG. 2, if “1000” is inputted as the second switching element control signal, for example, the column drive circuit 11F switches the state of the second switching element CS1 to the ON state. In this case, the column drive circuit 11F switches the state of the second switching element CS2 to the OFF state. In this case, the column drive circuit 11F switches the state of the second switching element CS3 to the OFF state. In this case, the column drive circuit 11F switches the state of the second switching element CS4 to the OFF state.

Thus, the snubber circuit 1 is able to switch the state of each first switching element RS to the ON state or the OFF state as necessary in response to the input of the control signal to the shift register 11A. As a result, the snubber circuit 1 is able to easily change the resistance value of the first resistor R. That is, the snubber circuit 1 is able to reduce the time required to adjust the resistance value of the first resistor R when the measurement of the radiation noise is performed. In addition, the snubber circuit 1 is able to switch the state of each second switching element CS to the ON state or the OFF state as necessary in response to the input of the control signal to the shift register 11A. As a result, the snubber circuit 1 is able to easily change the capacitance of the first capacitor C. That is, the snubber circuit 1 is able to reduce a time required to adjust the capacitance of the first capacitor C when the measurement of the radiation noise is performed.

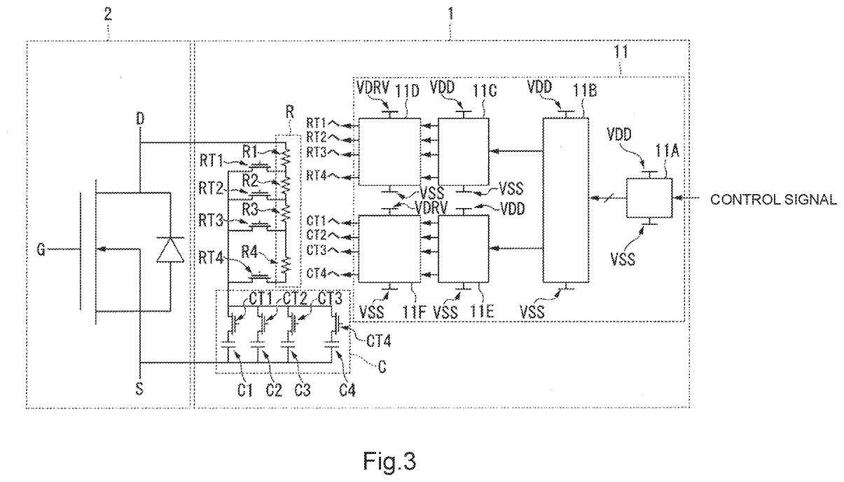

A specific example structure of the snubber circuit 1 will be described below with reference to FIG. 3. FIG. 3 is a diagram illustrating the specific example structure of the snubber circuit 1.

Referring to FIG. 3, when the snubber circuit 1 is constructed specifically, each first switching element RS is substituted with a field-effect transistor RT, for example. In FIG. 3, the field-effect transistor RT by which the first switching element RS1 is substituted is represented as a field-effect transistor RT1. In FIG. 3, the field-effect transistor RT by which the first switching element RS2 is substituted is represented as a field-effect transistor RT2. In FIG. 3, the field-effect transistor RT by which the first switching element RS3 is substituted is represented as a field-effect transistor RT3. In FIG. 3, the field-effect transistor RT by which the first switching element RS4 is substituted is represented as a field-effect transistor RT4. That is, in the case of the example illustrated in FIG. 3, the row drive circuit 11D switches the state of each of the field-effect transistors RT1 to RT4 as necessary based on the aforementioned first switching element control signal.

In addition, referring to FIG. 3, when the snubber circuit 1 is constructed specifically, each second switching element CS is, for example, substituted with a field-effect transistor CT. In FIG. 3, the field-effect transistor CT by which the second switching element CS1 is substituted is represented as a field-effect transistor CT1. In FIG. 3, the field-effect transistor CT by which the second switching element CS2 is substituted is represented as a field-effect transistor CT2. In FIG. 3, the field-effect transistor CT by which the second switching element CS3 is substituted is represented as a field-effect transistor CT3. In FIG. 3, the field-effect transistor CT by which the second switching element CS4 is substituted is represented as a field-effect transistor CT4. That is, in the case of the example illustrated in FIG. 3, the column drive circuit 11F switches the state of each of the field-effect transistors CT1 to CT4 as necessary based on the second switching element control signal.

In addition, referring to FIG. 3, when the snubber circuit 1 is constructed specifically, power supply voltages VDD and VSS are supplied to each of the shift register 11A, the address buffer 11B, the row decoder 11C, and the column decoder 11E, for example. In addition, in this case, power supply voltages VDRV and VSS are supplied to each of the row drive circuit 11D and the column drive circuit 11F, for example.

As described above, the snubber circuit 1 can be constructed specifically with the field-effect transistor RT used as each first switching element RS and the field-effect transistor CT used as each second switching element CS.

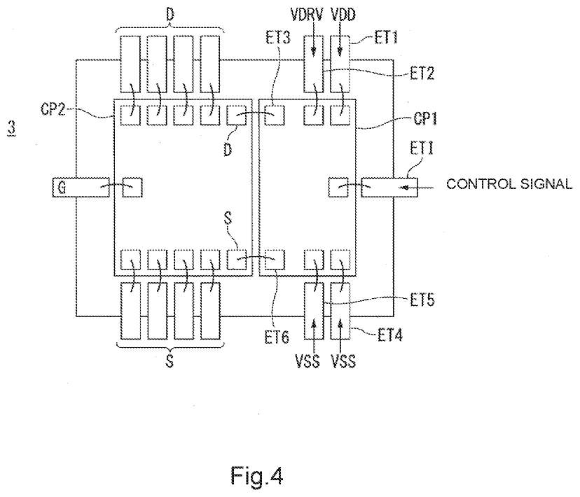

An example package structure of a power module 3 including the field-effect transistor 2 and the snubber circuit 1 will be described below with reference to FIG. 4. FIG. 4 is a diagram illustrating the example package structure of the power module 3 including the field-effect transistor 2 and the snubber circuit 1.

The power module 3 illustrated in FIG. 4 includes a first chip CP1 and a second chip CP2.

The first chip CP1 is a chip on which the snubber circuit 1 is integrated. The first chip CP1 may be constructed by either a known method or a method to be developed in the future.

An input terminal ETI illustrated in FIG. 4 is an input terminal through which the control signal is inputted to the shift register 11A. A terminal ET1 illustrated in FIG. 4 is a terminal through which the power supply voltage VDD is applied to each of the shift register 11A, the address buffer 11B, the row decoder 11C, and the column decoder 11E. A terminal ET2 illustrated in FIG. 4 is a terminal through which the power supply voltage VDRV is applied to each of the row drive circuit 11D and the column drive circuit 11F. A terminal ET3 illustrated in FIG. 4 is one of two terminals of the aforementioned first resistor R which is connected to the drain terminal D of the field-effect transistor 2. In the case of the example illustrated in FIG. 4, the terminal ET3 is connected to the drain terminal D through a wire bond.

A terminal ET4 illustrated in FIG. 4 is a terminal through which the power supply voltage VSS is applied to each of the shift register 11A, the address buffer 11B, the row decoder 11C, and the column decoder 11E. A terminal ET5 illustrated in FIG. 4 is a terminal through which the power supply voltage VSS is applied to each of the row drive circuit 11D and the column drive circuit 11F. A terminal ET6 illustrated in FIG. 4 is one of two terminals of the aforementioned first capacitor C which is connected to the source terminal S of the field-effect transistor 2. In the case of the example illustrated in FIG. 4, the terminal ET6 is connected to the source terminal S through a wire bond.

The second chip CP2 is a chip on which the field-effect transistor 2 is integrated. The second chip CP2 may be constructed by either a known method or a method to be developed in the future.

As described above, the field-effect transistor 2 and the snubber circuit 1 can be integrated on two separate chips. In addition, the two chips, i.e., the first chip CP1 and the second chip CP2, can be contained in a single package as the power module 3. This is an advantageous effect that can be achieved by configuring the snubber circuit 1 to enable the resistance value of the first resistor R to be varied without the need to replace the first resistor R. This is also an advantageous effect that can be achieved by configuring the snubber circuit 1 to enable the capacitance of the first capacitor C to be varied without the need to replace the first capacitor C.

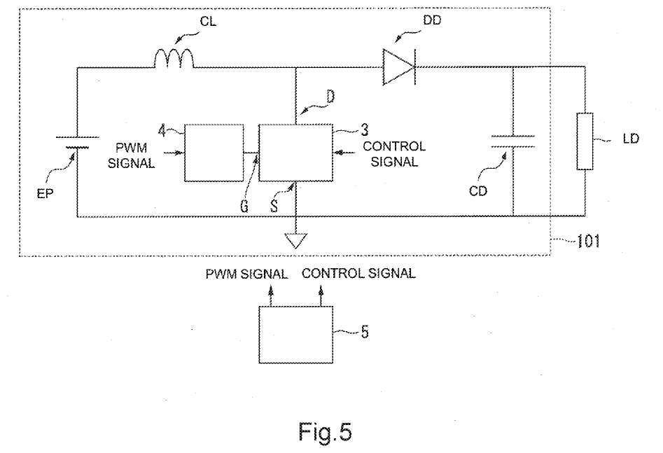

An example application of the power module 3 illustrated in FIG. 4 to a step-up circuit 101 will be described below with reference to FIG. 5. FIG. 5 is a diagram illustrating the example application of the power module 3 illustrated in FIG. 4 to the step-up circuit 101.

The step-up circuit 101 illustrated in FIG. 5 includes a direct-current power supply EP, a coil CL, a diode DD, a capacitor CD, the power module 3, and a gate driver 4. The step-up circuit 101 is connected to a load LD, and supplies a direct-current voltage to the load LD.

In the step-up circuit 101, a positive power supply terminal of the direct-current power supply EP is connected to one of two terminals of the coil CL. An anode of the diode DD is connected to the other one of the two terminals of the coil CL. A cathode of the diode DD is connected to one of terminals of the capacitor CD. The other one of the terminals of the capacitor CD is connected to a negative power supply terminal of the direct-current power supply EP. The drain terminal D of the second chip CP2 included in the power module 3 is connected to a transmission line that connects the coil CL and the diode DD. The source terminal S of the second chip CP2 included in the power module 3 is connected to a transmission line that connects the capacitor CD and the negative power supply terminal of the direct-current power supply EP. An output terminal of the gate driver 4 is connected to a gate terminal G of the second chip CP2 included in the power module 3. The load LD is connected to both ends of the capacitor CD through transmission lines.

That is, the step-up circuit 101 is a step-up circuit that includes the power module 3 in place of a conventional switching element.

In addition, in the step-up circuit 101, the control signal is inputted from a microcomputer 5 to the input terminal ETI included in the power module 3. Thus, the step-up circuit 101 is able to easily reduce the noise caused by a surge voltage that is generated at the time of a switching of the field-effect transistor 2. This field-effect transistor 2 is the field-effect transistor 2 integrated on the second chip CP2 included in the power module 3.

In addition, in the step-up circuit 101, a pulse width modulation (PWM) signal is inputted from the microcomputer 5 to an input terminal of the gate driver 4. Thus, the gate driver 4 switches the state of the field-effect transistor 2 integrated on the second chip CP2 included in the power module 3 to the ON state or the OFF state in accordance with the inputted PWM signal.

In addition, in the step-up circuit 101, the control signal is inputted from the microcomputer 5 to the input terminal ETI included in the power module 3. Thus, the step-up circuit 101 is able to easily reduce the noise caused by a surge voltage that is generated at the time of a switching of the field-effect transistor 2 integrated on the second chip CP2.

Note that the power module 3 may alternatively be used as a switching element in another circuit, such as, for example, a step-down circuit, instead of being applied to the step-up circuit.

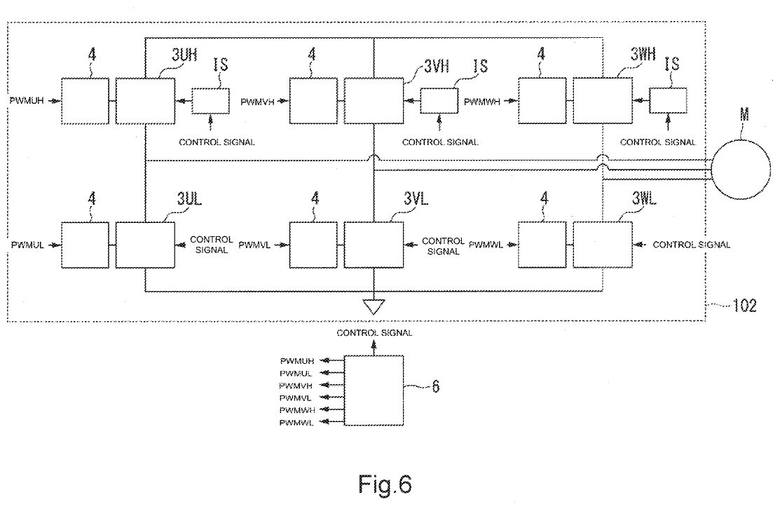

An example application of the power module 3 illustrated in FIG. 4 to an inverter circuit 102 will be described below with reference to FIG. 6. FIG. 6 is a diagram illustrating the example application of the power module 3 illustrated in FIG. 4 to the inverter circuit 102.

The inverter circuit 102 performs switching control on a three-phase direct-current motor M in accordance with PWM signals inputted from a microcomputer 6.

The inverter circuit 102 includes three power modules 3 as three switching elements on a high side. In FIG. 6, one of the three power modules 3 which corresponds to a U phase of the three-phase direct-current motor M is represented as a power module 3UH. In FIG. 6, one of the three power modules 3 which corresponds to a V phase of the three-phase direct-current motor M is represented as a power module 3VH. In FIG. 6, one of the three power modules 3 which corresponds to a W phase of the three-phase direct-current motor M is represented as a power module 3WH.

In addition, the inverter circuit 102 includes three power modules 3 as three switching elements on a low side. In FIG. 6, one of the three power modules 3 which corresponds to the U phase of the three-phase direct-current motor M is represented as a power module 3UL. In FIG. 6, one of the three power modules 3 which corresponds to the V phase of the three-phase direct-current motor M is represented as a power module 3VL. In FIG. 6, one of the three power modules 3 which corresponds to the W phase of the three-phase direct-current motor M is represented as a power module 3WL.

Here, each of the three power modules 3 on the high side has a different ground potential. Accordingly, in the inverter circuit 102, the control signal is inputted from the microcomputer 6 to each of the three power modules 3 through an isolator IS. That is, the inverter circuit 102 includes three isolators IS as illustrated in FIG. 6.

In FIG. 6, “PWMUH” represents a PWM signal to be inputted to the power module 3UH from the microcomputer 6. In FIG. 6, “PWMVH” represents a PWM signal to be inputted to the power module 3VH from the microcomputer 6. In FIG. 6, “PWMWH” represents a PWM signal to be inputted to the power module 3WH from the microcomputer 6. In FIG. 6, “PWMUL” represents a PWM signal to be inputted to the power module 3UL from the microcomputer 6. In FIG. 6, “PWMVL” represents a PWM signal to be inputted to the power module 3VL from the microcomputer 6. In FIG. 6, “PWMWL” represents a PWM signal to be inputted to the power module 3WL from the microcomputer 6.

As described above, in the example illustrated in FIG. 6, the inverter circuit 102 includes the six power modules 3 as six switching elements. Thus, the inverter circuit 102 is able to easily reduce noise caused by a surge voltage that is generated at the time of a switching of the field-effect transistor 2 included in each of the six power modules 3.

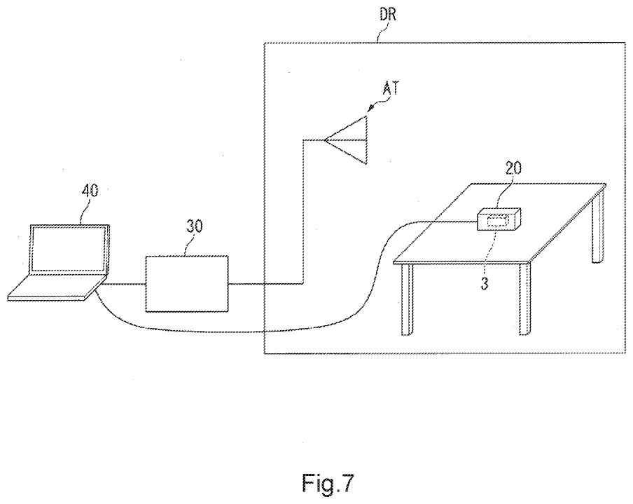

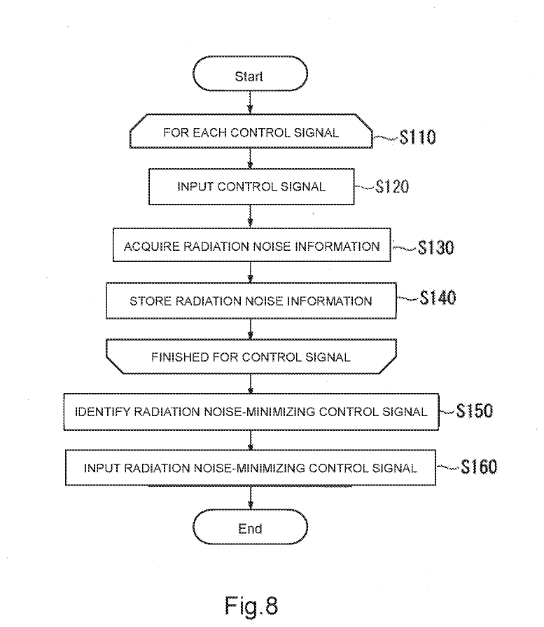

A method of measuring radiation noise of an electronic device 20 including the power module 3 illustrated in FIG. 4 will be described below with reference to FIGS. 7 and 8.

FIG. 7 is a diagram illustrating an example structure of a measuring system for measuring the radiation noise of the electronic device 20 including the power module 3 illustrated in FIG. 4. This measuring system includes the electronic device 20, with respect to which the radiation noise is measured, a receiver equipped with an antenna AT, and an information processing apparatus 40. In addition, in the measuring system, the electronic device 20 is placed inside an anechoic chamber DR.

The electronic device 20 is, for example, a circuit including the power module 3 as a switching element of a converter circuit, an inverter circuit, or the like, or any of various electronic devices including such a circuit. In addition, the electronic device 20 further includes a microcomputer, which is not shown in FIG. 7. In the following description, this microcomputer will be referred to as a control microcomputer for the sake of convenience in description. The control microcomputer inputs the control signal to the power module 3 included in the electronic device 20. The control microcomputer sets the resistance value of the first resistor R included in the power module 3, and the capacitance of the first capacitor C included in the power module 3.

The antenna AT is an antenna that receives electromagnetic waves. The antenna AT is connected to the receiver 30. Here, inside the anechoic chamber DR, the antenna AT is placed at a position in accordance with a standard for the measurement of the radiation noise.

The receiver 30 is an electromagnetic interference test receiver. The receiver 30 acquires the intensity of an electromagnetic wave received by the antenna AT as radiation noise information representing the magnitude of the radiation noise of the electronic device 20. The receiver 30 outputs the radiation noise information acquired through the antenna AT to the information processing apparatus 40.

The information processing apparatus 40 is, for example, a notebook personal computer (PC). Note that the information processing apparatus 40 may alternatively be, instead of the notebook PC, another information processing apparatus, such as, for example, a workstation, a desktop PC, a tablet PC, a multifunction cellular phone terminal (smart phone), a cellular phone terminal, or a personal digital assistant (PDA).

The information processing apparatus 40 acquires the radiation noise information from the receiver 30. In addition, the information processing apparatus 40 performs various processes in accordance with the acquired radiation noise information. The various processes include an analysis of the radiation noise of the electronic device 20, an evaluation of the radiation noise, and so on.

In addition, the information processing apparatus 40 is connected to the microcomputer included in the electronic device through a communication cable. The information processing apparatus 40 outputs the control signal to the control microcomputer. Thus, the information processing apparatus 40 sets the resistance value of the first resistor R included in the power module 3 to the resistance value corresponding to the control signal. In addition, the information processing apparatus 40 sets the capacitance of the first capacitor C included in the power module 3 to the capacitance value corresponding to the control signal.

FIG. 8 is a flowchart illustrating an example flow of a procedure performed by the information processing apparatus 40 to perform the measurement of the radiation noise of the electronic device 20. An example case where an operation of starting the measurement is accepted by the information processing apparatus 40 before a process of step S110 illustrated in FIG. 8 is performed is described below. An example case where the PWM signals are periodically outputted from the control microcomputer to the field-effect transistor 2 is described below.

The information processing apparatus 40 selects a plurality of different serial signals one after another as a target control signal to repeatedly perform processes of steps S120, S130, and S140 with respect to each selected control signal (step S110). In the present example embodiment, the serial signals are 4-bit serial signals as mentioned above. In addition, in the present example embodiment, each of the plurality of different serial signals represents a different 4-bit value. For example, a serial signal representing “0000” and a serial signal representing “0001” are mutually different serial signals.

The information processing apparatus 40 inputs the control signal selected at step S110 to the control microcomputer (step S120). Once the control signal is inputted, the control microcomputer inputs the inputted control signal to the shift register 11A integrated on the first chip CP1. Thus, the control microcomputer sets the resistance value of the first resistor R included in the power module 3 to the resistance value corresponding to the control signal. In addition, the control microcomputer sets the capacitance of the first capacitor C included in the power module 3 to the capacitance value corresponding to the control signal.

Next, the information processing apparatus 40 acquires the radiation noise information representing the magnitude of the radiation noise of the electronic device 20 (step S130). Specifically, the information processing apparatus 40 acquires, from the receiver 30, the radiation noise information representing the magnitude of the radiation noise detected by the antenna AT.

Next, the information processing apparatus 40 stores the radiation noise information acquired at step S130 in a storage portion (not shown) included in the information processing apparatus 40 (step S140). At this time, the information processing apparatus 40 stores, in the storage portion, the radiation noise information with the control signal selected at step S110 associated therewith.

After the process of step S140 is performed, the information processing apparatus 40 proceeds to step S110, and selects the next control signal. Note that, if there is no unselected serial signal that can be selected as the next control signal when the information processing apparatus 40 has proceeded to step S110, the information processing apparatus 40 proceeds to step S150.

After repeating the processes of steps S110 to S140, the information processing apparatus 40 identifies a radiation noise-minimizing control signal (step S150). Specifically, the information processing apparatus 40 identifies, from among the plurality of pieces of radiation noise information stored in the storage portion included in the information processing apparatus 40, a piece of radiation noise information that represents the smallest magnitude of the radiation noise. The information processing apparatus 40 identifies the control signal associated with the identified radiation noise information as the radiation noise-minimizing control signal.

Next, the information processing apparatus 40 inputs the radiation noise-minimizing control signal identified at step S150 to the control microcomputer (step S160), and ends the procedure. Once the radiation noise-minimizing control signal is inputted to the control microcomputer, the control microcomputer inputs the inputted radiation noise-minimizing control signal to the shift register 11A included in the power module 3. Thus, the control microcomputer sets the resistance value of the first resistor R included in the power module 3 to the resistance value corresponding to the radiation noise-minimizing control signal. In addition, the control microcomputer sets the capacitance of the first capacitor C included in the power module 3 to the capacitance value corresponding to the radiation noise-minimizing control signal.

The information processing apparatus 40 performs the measurement of the radiation noise of the electronic device 20 in accordance with the above-described procedure. In this manner, the information processing apparatus 40 is able to input the radiation noise-minimizing control signal to the control microcomputer without the need to repeat at least one of the two adjustments and the measurement of the radiation noise of the electronic device 20. The two adjustments are the adjustment of the resistance value of the first resistor R included in the electronic device 20, and the adjustment of the capacitance of the first capacitor C included in the electronic device 20. That is, the information processing apparatus 40 is able to automatically minimize the radiation noise of the electronic device 20, reducing the effort and time required to adjust the power module 3 included in the electronic device 20.

The procedure of the flowchart illustrated in FIG. 8 is performed when, for example, the measurement of the radiation noise of the power module 3 or the electronic device including the power module 3 is performed. For example, when the measurement of the radiation noise is performed, one of a plurality of power modules 3 produced in a production line is extracted as a sample, and the above procedure is performed with respect to the extracted sample. At this time, the identified radiation noise-minimizing control signal is inputted to each of the plurality of power modules 3. Thus, the snubber circuit 1 is able to easily achieve a reduction in the radiation noise with respect to each of the plurality of power modules 3.

Note that the communication cable that connects the information processing apparatus 40 and the control microcomputer to each other may include a debugger.

In the example illustrated in FIGS. 7 and 8, at least one of the resistance value of the first resistor R and the capacitance of the first capacitor C included in the electronic device 20 is adjusted by the information processing apparatus 40 based on the result of the measurement of the radiation noise of the electronic device 20. In a modification of the above-described example embodiment, the above adjustment of the electronic device 20 is performed without the measurement of the radiation noise of the electronic device 20 being performed.

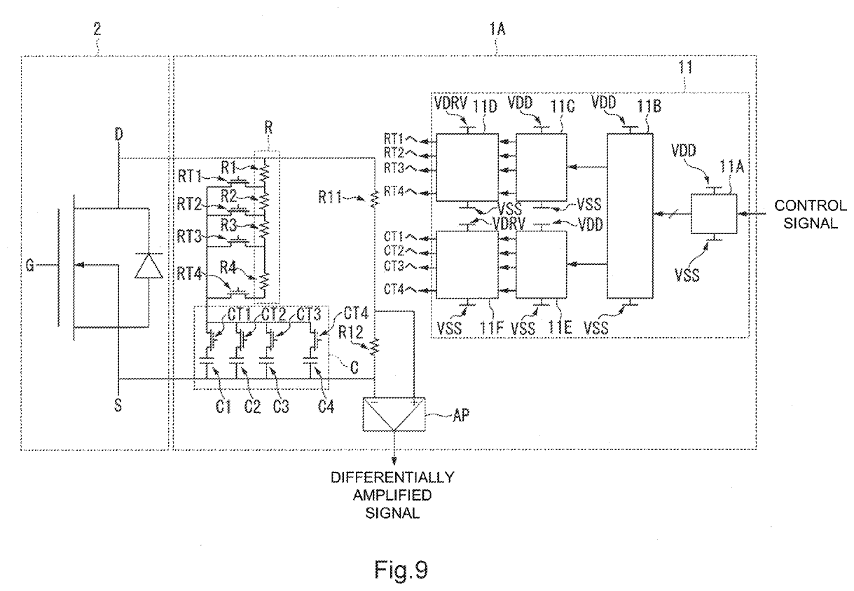

FIG. 9 is a diagram illustrating a specific example structure of the field-effect transistor 2 with a snubber circuit 1A according to a modification of the above-described example embodiment connected thereto. The snubber circuit 1A subjects a surge voltage that is generated at the time of a switching of the field-effect transistor 2 to differential amplification, and outputs a differentially amplified signal representing the differentially amplified surge voltage to a microcomputer. This microcomputer is a microcomputer that inputs a control signal to the shift register 11A.

The snubber circuit 1A illustrated in FIG. 9 is an example circuit similar to the snubber circuit 1 illustrated in FIG. 3 except that a resistor R11, a resistor R12, and a differential amplifier circuit AP are additionally connected. The structure of the field-effect transistor 2 illustrated in FIG. 9 is identical to the structure of the field-effect transistor 2 illustrated in FIG. 3, and a description thereof is therefore omitted.

In the example illustrated in FIG. 9, in the snubber circuit 1A, a transmission line that connects the drain terminal D and the second resistor R1 is connected to the resistor R11. Of two terminals of the resistor R11, the terminal that is not connected to the above transmission line is connected to the resistor R12. Of terminals of the resistor R12, the terminal that is not connected to the resistor R11 is connected to an inverting input terminal of the differential amplifier circuit AP. A transmission line that connects the above terminal and the inverting input terminal is connected to a transmission line that connects the second capacitor C4 and the source terminal S. A transmission line that connects the resistor R11 and the resistor R12 is connected to a non-inverting input terminal of the differential amplifier circuit AP.

The structure of the snubber circuit 1A is identical to the structure of the snubber circuit 1 illustrated in FIG. 3 except in features related to the resistor R11, the resistor R12, and the differential amplifier circuit AP, and accordingly, redundant description is omitted.

Having such a structure, the snubber circuit 1A is able to differentially amplify a surge voltage generated at the time of a switching of the field-effect transistor 2 through the differential amplifier circuit AP. The snubber circuit 1A outputs the differentially amplified signal representing the surge voltage differentially amplified through the differential amplifier circuit AP to the microcomputer. This microcomputer is the microcomputer that inputs the control signal to the shift register 11A. The resistor R11 and the resistor R12 are resistors that subject the surge voltage to voltage division.

Since the snubber circuit 1A outputs the differentially amplified signal as described above, the microcomputer that inputs the control signal to the shift register 11A is able to identify a control signal that minimizes the magnitude of the acquired differentially amplified signal. Then, the microcomputer is able to adjust at least one of the resistance value of the first resistor R and the capacitance of the first capacitor C based on the identified control signal to minimize the magnitude of the acquired differentially amplified signal. That is, an electronic device 20 including the snubber circuit 1A is able to perform the above adjustment without the measurement of the radiation noise of the electronic device 20 being performed. As a result, the snubber circuit 1A is able to reduce the time required for the above adjustment performed when the measurement of the radiation noise of the electronic device 20 is performed.

Similarly to the snubber circuit 1, the snubber circuit 1A as described above can be integrated on the first chip CP1 included in the power module 3. For the sake of convenience in description, the chip on which the snubber circuit 1A is integrated will be referred to as a first chip CP1A in the following description. In addition, for the sake of convenience in description, the power module 3 including the first chip CP1A in place of the first chip CP1 will be referred to as a power module 3A in the following description.

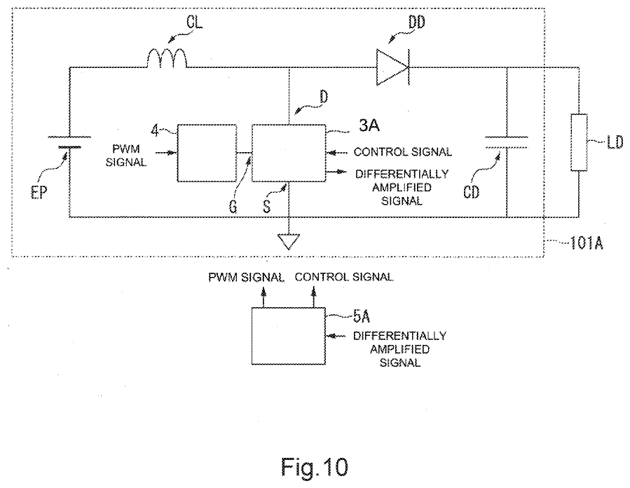

FIG. 10 is a diagram illustrating an example structure of a step-up circuit 101A including the power module 3A. As illustrated in FIG. 10, the step-up circuit 101A is a circuit identical to the step-up circuit 101 except that the power module 3 is replaced with the power module 3A. Accordingly, the power module 3A outputs the above-described differentially amplified signal to a microcomputer 5A. In addition to having the functions of the microcomputer 5, the microcomputer 5A acquires the differentially amplified signals from the power module 3A of the step-up circuit 101A. Based on the acquired differentially amplified signals, the microcomputer 5A inputs the control signal that minimizes the magnitude of the differentially amplified signal to the power module 3A. Thus, the step-up circuit 101A is able to reduce the radiation noise based on the differentially amplified signal obtained by differentially amplifying the surge voltage generated at the time of a switching of the field-effect transistor 2, without the need to perform the measurement of the radiation noise.

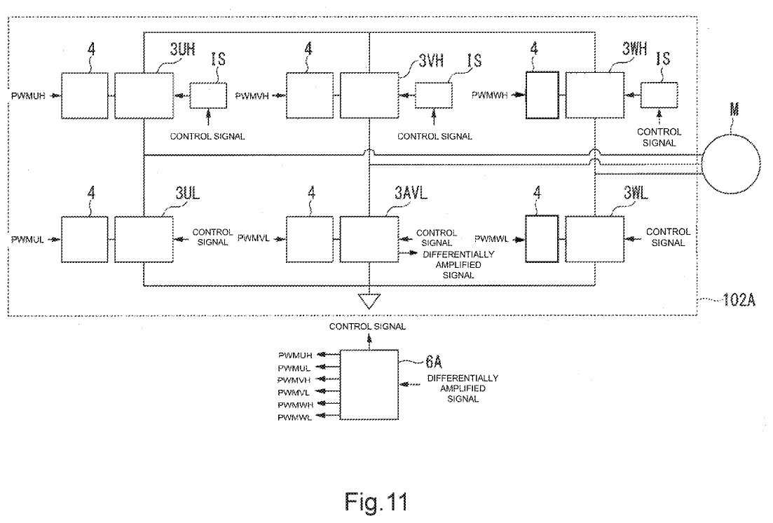

FIG. 11 is a diagram illustrating an example structure of an inverter circuit 102A including the power module 3A. Here, the inverter circuit 102 illustrated in FIG. 6 includes the six power modules 3 as described above. The six power modules 3 are the power module 3UH, the power module 3VH, the power module 3WH, the power module 3UL, the power module 3VL, and the power module 3WL. The field-effect transistor 2 included in each of these power modules 3 has the same structure. Accordingly, each of the six power modules 3 generates a surge voltage of substantially the same magnitude at the time of a switching.

Because of the above circumstances, the inverter circuit 102A is, for example, a circuit identical to the inverter circuit 102 except that the power module 3VL is replaced with the power module 3A. For the sake of convenience in description, this power module 3A will be referred to as a power module 3AVL in the following description. Note that the inverter circuit 102A may alternatively be a circuit identical to the inverter circuit 102 except that one of the power modules 3 other than the power module 3VL is replaced with the power module 3A. Also note that the inverter circuit 102A may alternatively be a circuit identical to the inverter circuit 102 except that two or more of the power modules 3 are replaced with the power modules 3A.

The control signal is inputted from a microcomputer 6A, in place of the microcomputer 6, to each of the power modules 3 and the power module 3A included in the inverter circuit 102A. The microcomputer 6A acquires the differentially amplified signals from the power module 3AVL. Based on the acquired differentially amplified signals, the microcomputer 6A inputs the control signal that minimizes the magnitude of the differentially amplified signal to each of the five power modules 3 included in the inverter circuit 102A. In addition, the microcomputer 6A inputs this control signal to the power module 3AVL included in the inverter circuit 102A. Here, the five power modules 3 are the power module 3UH, the power module 3VH, the power module 3WH, the power module 3UL, and the power module 3WL. Thus, the inverter circuit 102A is able to reduce the radiation noise based on the differentially amplified signal obtained by differentially amplifying the surge voltage generated at the time of a switching of the field-effect transistor 2, without the need to perform the measurement of the radiation noise.

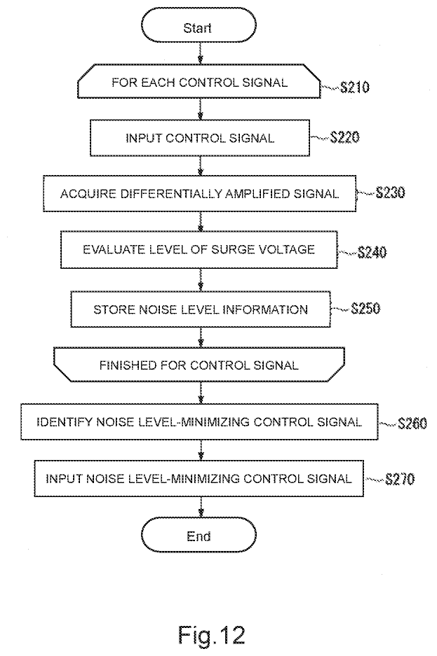

FIG. 12 is a flowchart illustrating an example flow of a procedure performed by the microcomputer to adjust at least one of the resistance value of the first resistor R and the capacitance of the first capacitor C in the power module 3A. In the following description, this microcomputer will be referred to as a second control microcomputer for the sake of convenience in description. An example case where an operation of starting the above adjustment is accepted by the second control microcomputer before a process of step S210 illustrated in FIG. 12 is performed is described below.

The second control microcomputer selects a plurality of different serial signals one after another as a target control signal to repeatedly perform processes of steps S220, S230, S240, and S250 with respect to each selected control signal (step S210).

The second control microcomputer inputs the control signal selected at step S210 to the shift register 11A of the snubber circuit 1A included in the power module 3A (step S220). Thus, the second control microcomputer sets the resistance value of the first resistor R included in the power module 3A to the resistance value corresponding to the control signal. In addition, the second control microcomputer sets the capacitance of the first capacitor C included in the power module 3A to the capacitance value corresponding to the control signal.

Next, the second control microcomputer acquires the differentially amplified signal from the differential amplifier circuit AP included in the power module 3A (step S230).

Next, the second control microcomputer evaluates the noise level of the surge voltage based on the differentially amplified signal acquired at step S230 (step S240). More specifically, the second control microcomputer, for example, performs an FFT analysis based on the differentially amplified signal to evaluate the noise level of the surge voltage. The noise level may be evaluated by either a known method or a method to be developed in the future.

Next, the second control microcomputer stores noise level information representing the noise level evaluated at step S240 in a storage portion (not shown) included in the second control microcomputer (step S250). At this time, the second control microcomputer stores, in the storage portion, the noise level information with the control signal selected at step S210 associated therewith.

After the process of step S250 is performed, the second control microcomputer proceeds to step S210, and selects the next control signal. Note that, if there is no unselected serial signal that can be selected as the next control signal when the second control microcomputer has proceeded to step S210, the second control microcomputer proceeds to step S260.

After repeating the processes of steps S210 to S250, the second control microcomputer identifies a noise level-minimizing control signal (step S260). Specifically, the second control microcomputer identifies, from among the plurality of pieces of noise level information stored in the storage portion included in the second control microcomputer, a piece of noise level information that represents the lowest noise level. The second control microcomputer identifies the control signal associated with the identified noise level information as the noise level-minimizing control signal.

Next, the second control microcomputer inputs the noise level-minimizing control signal identified at step S260 to the shift register 11A of the snubber circuit 1A included in the power module 3A (step S270), and ends the procedure. Thus, the second control microcomputer sets the resistance value of the first resistor R included in the power module 3A to the resistance value corresponding to the noise level-minimizing control signal. In addition, the second control microcomputer sets the capacitance of the first capacitor C included in the power module 3A to the capacitance value corresponding to the noise level-minimizing control signal.

The second control microcomputer adjusts at least one of the resistance value of the first resistor R and the capacitance of the first capacitor C in the power module 3A in accordance with the above-described procedure. Thus, the second control microcomputer is able to input the noise level-minimizing control signal to the power module 3A without the need to perform the measurement of the radiation noise of the power module 3A or an electronic device including the power module 3A. Note that the second control microcomputer is an example of the information processing apparatus.

The procedure of the flowchart illustrated in FIG. 12 is performed when, for example, the measurement of the radiation noise of the power module 3A or the electronic device including the power module 3A is performed. At this time, the identified noise level-minimizing control signal is inputted to the power module 3A. Thus, the snubber circuit 1A is able to easily achieve a reduction in the radiation noise of the power module 3A.

Each of the power module 3 and the power module 3A according to the above-described example embodiments includes only one field-effect transistor 2. Note, however, that each of the power module 3 and the power module 3A may alternatively include two or more of the field-effect transistors 2. That is, each of the power module 3 and the power module 3A may alternatively include two or more of the target switching elements.

Also note that the snubber circuit 1A described above may alternatively be configured to include, in place of the differential amplifier circuit AP, a circuit for measuring a voltage between the drain terminal D and the source terminal S of the field-effect transistor 2, and outputting information representing the measured voltage to the second control microcomputer. That is, the snubber circuit 1A may not necessarily be configured to differentially amplify the above voltage.

As described above, a snubber circuit according to an example embodiment of the present disclosure is a snubber circuit connected to a target switching element, and including a first capacitor, and a first resistor capable of being varied in a resistance value. Thus, the snubber circuit is able to reduce a time required to adjust the resistance value of the first resistor when, for example, a measurement of radiation noise is performed.

In the snubber circuit, the first resistor may include two or more second resistors connected in series, and the snubber circuit may further include two or more first switching elements arranged to change the number of second resistors that are electrically connected among the two or more second resistors.

The snubber circuit may be configured such that one of the two second resistors positioned at both ends of the two or more second resistors is connected to one of two terminals of the target switching element; and that, of two terminals of each of the two or more second resistors, the terminal that is arranged on an opposite side with respect to the target switching element in the first resistor is connected to the first capacitor with the corresponding first switching element therebetween.

In the snubber circuit, the first capacitor may be capable of being varied in capacitance.

The snubber circuit may be configured such that the first capacitor includes two or more second capacitors connected in parallel, and two or more second switching elements arranged to change the state of electrical connection of one of two terminals of each of the two or more second capacitors; and that one of the two terminals of each of the two or more second capacitors is connected to one of the two or more second switching elements.

In connection with the snubber circuit, the target switching element may be a field-effect transistor.

The snubber circuit may further include a control circuit arranged to control the resistance value of the first resistor.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A snubber circuit connected to a target switching element, the snubber circuit comprising:
a first capacitor; and
a first resistor with a variable resistance value.

2. The snubber circuit according to claim 1, wherein
the first resistor includes two or more second resistors connected in series; and
the snubber circuit includes two or more first switching elements that change a number of second resistors that are electrically connected among the two or more second resistors.

3. The snubber circuit according to claim 2, wherein
one of the two or more second resistors positioned at an end of the two or more second resistors connected in series is connected to one of two terminals of the target switching element; and
of two terminals of each of the two or more second resistors, a terminal that is on an opposite side with respect to the target switching element in the first resistor is connected to the first capacitor with the corresponding first switching element therebetween.

4. The snubber circuit according to claim 1, wherein the first capacitor has a variable capacitance.

5. The snubber circuit according to claim 4, wherein
the first capacitor includes:
two or more second capacitors connected in parallel; and
two or more second switching elements that change a state of electrical connection of one of two terminals of each of the two or more second capacitors; and
one of the two terminals of each of the two or more second capacitors is connected to one of the two or more second switching elements.

6. The snubber circuit according to claim 1, wherein the target switching element is a field-effect transistor.

7. The snubber circuit according to claim 1, further comprising a control circuit that controls the resistance value of the first resistor.

8. A control circuit to control the resistance value of the first resistor included in the snubber circuit of claim 1.

9. An information processing apparatus that reduces radiation noise of an electronic device including the snubber circuit of claim 1, wherein
the electronic device is located in an anechoic chamber; and
the information processing apparatus acquires an intensity of an electromagnetic wave emitted from the electronic device and received by an antenna in the anechoic chamber as radiation noise information representing a magnitude of the radiation noise, and changes the resistance value of the first resistor based on the acquired radiation noise information.

10. An information processing apparatus that reduces radiation noise of an electronic device including the snubber circuit of claim 1, wherein
the snubber circuit acquires a voltage between terminals of the target switching element, and changes the resistance value of the first resistor based on the acquired voltage between the terminals.

11. The snubber circuit according to claim 2, wherein the first capacitor has a variable capacitance.

12. The snubber circuit according to claim 2, wherein the target switching element is a field-effect transistor.

13. The snubber circuit according to claim 3, wherein the target switching element is a field-effect transistor.

14. The snubber circuit according to claim 4, wherein the target switching element is a field-effect transistor.

15. The snubber circuit according to claim 5, wherein the target switching element is a field-effect transistor.

16. The snubber circuit according to claim 2, further comprising a control circuit to control the resistance value of the first resistor.

17. The snubber circuit according to claim 3, further comprising a control circuit to control the resistance value of the first resistor.

18. The snubber circuit according to claim 4, further comprising a control circuit to control the resistance value of the first resistor.

19. The snubber circuit according to claim 5, further comprising a control circuit to control the resistance value of the first resistor.

20. The snubber circuit according to claim 6, further comprising a control circuit to control the resistance value of the first resistor.
